(19) United States
(12) Patent Application Publication
(10) Pub. No.: US 2022/0365617 A1
(43) Pub. Date: Nov. 17, 2022

(54) INSTRUCTION INPUT DEVICE, CONTROL DEVICE, AND NON-TRANSITORY COMPUTER-READABLE MEDIUM

(71) Applicant: KABUSHIKI KAISHA TOKAI RIKA DENKI SEISAKUSHO, Aichi (JP)

(72) Inventor: Takao ARAYA, Aichi (JP)

(73) Assignee: KABUSHIKI KAISHA TOKAI RIKA DENKI SEISAKUSHO, Aichi (JP)

(21) Appl. No.: 17/773,248

(22) PCT Filed: Sep. 25, 2020
(86) PCT No.: PCT/JP2020/036261

§ 371 Date: Apr. 29, 2022

(30) Foreign Application Priority Data
Nov. 7, 2019 (JP) 2019-202276

(51) Int. Cl. G06F 3/044

(52) U.S. Cl. CPC G06F 3/044

(57) ABSTRACT

An instruction input device is adapted to be installed in a mobile entity. A movable part is configured to be displaced. A first sensor is configured to detect an electrostatic capacitance at the movable part. A second sensor is configured to detect a position of the movable part. A control device is configured to output a detection signal indicating that an instruction input is performed through the movable part in a case where a variation in the electrostatic capacitance exceeds a first threshold value and a first displacement amount that is a displacement amount of the movable part from an initial position thereof exceeds a second threshold value.

### FIELD

The presently disclosed subject matter relates to an instruction input device adapted to be installed in a mobile entity. The presently disclosed subject matter also relates to a control device adapted to be installed in a mobile entity, as well as a computer program adapted to be executed by the control device.

### BACKGROUND

Japanese Patent Publication No. 2019-018771A discloses an instruction input device based on an electrostatic capacitance detection system adapted to be installed in a vehicle as an example of the mobile entity. The device accepts an instruction input of a user by detecting a change in electrostatic capacitance caused by the approach or contact of the user's body.

### SUMMARY

### Technical Problem

It is demanded to improve the convenience of the instruction input device based on the electrostatic capacitance detection system adapted to be installed in the mobile entity.

### Solution to Problem

In order to meet the demand described above, an illustrative aspect of the presently disclosed subject matter provides an instruction input device adapted to be installed in a mobile entity, comprising:

a movable part configured to be displaced;

a first sensor configured to detect an electrostatic capacitance at the movable part;

a second sensor configured to detect a position of the movable part; and

a control device configured to output a signal indicating that an instruction input is performed through the movable part in a case where a variation in the electrostatic capacitance exceeds a first threshold value and a first displacement amount that is a displacement amount of the movable part from an initial position thereof exceeds a second threshold value.

In order to meet the demand described above, an illustrative aspect of the presently disclosed subject matter provides a control device adapted to be installed in a mobile entity, comprising:

an input interface configured to receive a first signal corresponding to an electrostatic capacitance at a movable part that is configured to be displaced, and a second signal corresponding to a position of the movable part; and

a processor configured to:
determine, based on the first signal and the second signal, whether it is satisfied a condition in which a variation in the electrostatic capacitance exceeds a first threshold value and a first displacement amount that is a displacement amount of the movable part from an initial position thereof exceeds a second threshold value; and
output a signal indicating that an instruction input is performed through the movable part in a case where the condition is satisfied.

In order to meet the demand described above, an illustrative aspect of the presently disclosed subject matter provides a non-transitory computer-readable medium having stored a computer program adapted to be executed by a processor of a control device adapted to be installed in a mobile entity, the computer program being configured, when executed, to cause the control device to:

receive a first signal corresponding to an electrostatic capacitance at a movable part that is configured to be displaced, and a second signal corresponding to a position of the movable part;

determine, based on the first signal and the second signal, whether it is satisfied a condition in which a variation in the electrostatic capacitance exceeds a first threshold value and a first displacement amount that is a displacement amount of the movable part from an initial position thereof exceeds a second threshold value; and

output a signal indicating that an instruction input is performed through the movable part in a case where the condition is satisfied.

With the configuration according to each of the illustrative aspects, it is possible to enable the control device to determine that an instruction input is performed in a case where an operation is performed with a load sufficient to cause a displacement exceeding the second threshold value is applied to the movable part. For example, even if a user boarding the vehicle touches the movable part unintentionally so that the variation in the electrostatic capacitance of the movable part exceeds the first threshold value, the control device does not determine that an instruction input is performed with respect to the movable part. Since it is possible to suppress the occurrence of a situation that the controlled device happens to be operated based on an unintended contact with the movable part, it is possible to improve the convenience of the instruction input device based on the electrostatic capacitance detection system adapted to be installed in the mobile entity.

### BRIEF DESCRIPTION OF DRAWINGS

FIG. 1 illustrates a functional configuration of an instruction input device according to an embodiment.

FIG. 2 illustrates a vehicle in which the instruction input device of FIG. 1 is to be installed.

FIG. 3 illustrates an exemplary processing to be executed by a control device of FIG. 1.

FIG. 4 illustrates an operation of the instruction input device of FIG. 1.

FIG. 5 illustrates another exemplary processing to be executed by the control device of FIG. 1.

### DESCRIPTION OF EMBODIMENTS

Examples of embodiments will be described in detail below with reference to the accompanying drawings. In each of the drawings used in the following description, the scale is appropriately changed in order to make each member have a recognizable size.

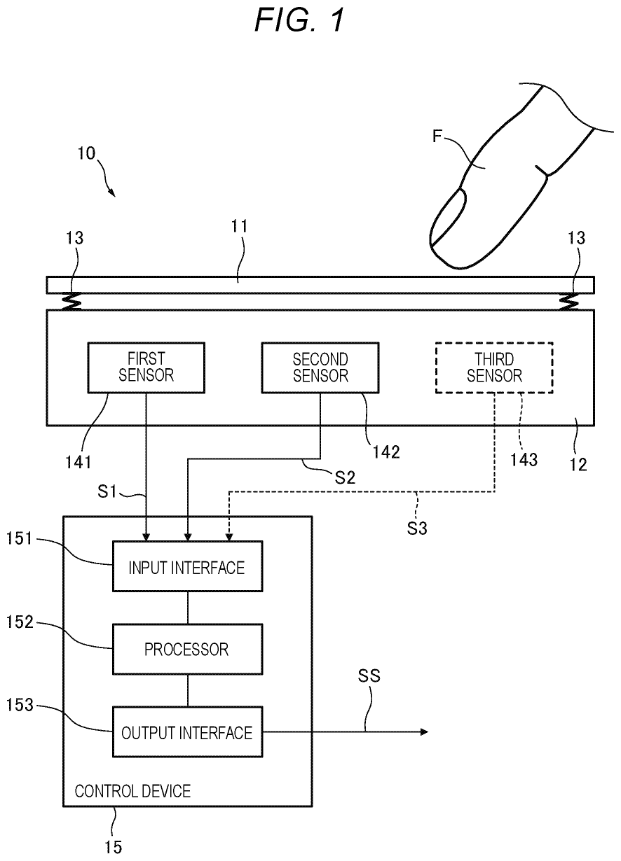

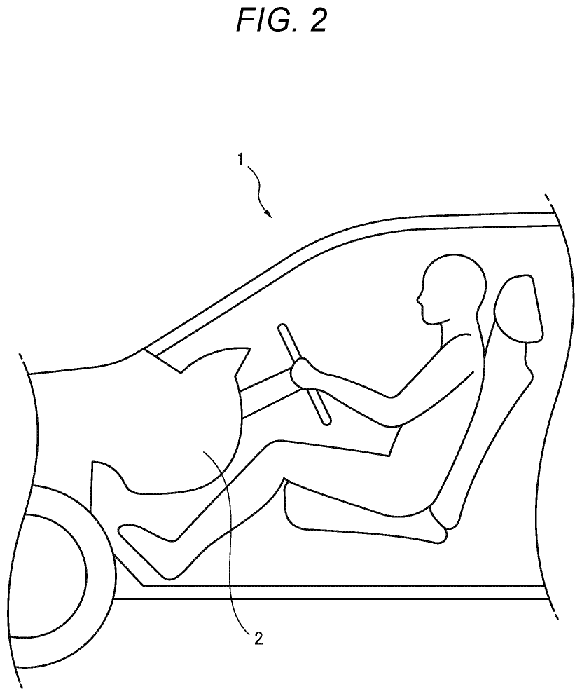

FIG. 1 illustrates a functional configuration of an instruction input device 10 according to an embodiment. The instruction input device 10 may be installed in a center cluster 2 of a vehicle 1 as illustrated in FIG. 2. The vehicle 1 is an example of a mobile entity. In this case, the instruction input device 10 is used for inputting an instruction for controlling the operation of a controlled device installed in the vehicle 1. Examples of the controlled device include an audio-visual equipment, an air conditioner, a navigation device, and a lighting device.

The instruction input device 10 includes a movable part 11, a base part 12, and an elastic member 13. The movable part 11 is formed of a material having a dielectric property. The base part 12 is adapted to be fixed to the vehicle 1. The movable part 11 is connected to the base part 12 via the elastic member 13 such that the movable part 11 is movable relative to the base part 12. Examples of the elastic member 13 include a spring, a rubber pad, and the like.

The instruction is inputted by performing a touch operation on the movable part 11 with a finger F of a user. In this example, the user is an occupant of the vehicle 1. As used herein, the term “touch operation” means an operation involving contact of a portion of the user's body with the movable part 11.

The instruction input device 10 includes a first sensor 141. The first sensor 141 is configured to detect an electrostatic capacitance of the movable part 11. For example, the first sensor 141 includes an electrode (not illustrated) provided on the base part 12. The electrode is disposed so as to face the movable part 11. The first sensor 141 is configured to output a first signal Si corresponding to an electrostatic capacitance between the movable part 11 and the electrode. The first signal S1 may be an analog signal or a digital signal.

Specifically, the first sensor 141 includes a charging/discharging circuit (not illustrated). The charging/discharging circuit is electrically connected to the electrode. The charging/discharging circuit can perform a charging operation and a discharging operation. The charging/discharging circuit during the charging operation feeds current supplied from a power source (not illustrated) to the electrode. The charging/discharging circuit causes the electrode to emit current during the discharging operation. An electric field is generated around the movable part 11 by the current supplied to the electrode. When the finger F of the user approaches this electric field, a pseudo capacitor is formed between the electrode and the finger F. As a result, the electrostatic capacitance between the electrode and the movable part 11 is increased. As the electrostatic capacitance increases, the current emitted from the electrode during the discharging operation increases. The first sensor 141 reflects the value of the current in the first signal S1.

The instruction input device 10 includes a second sensor 142. The second sensor 142 is configured to detect the position of the movable part 11. For example, the second sensor 142 includes a distance sensor (not illustrated) provided on the base part 12. The distance sensor is disposed so as to face the movable part 11. The distance sensor may be configured to specify a distance between the movable part 11 and the base part 12 based on, for example, a time length from when light is emitted from a light emitting element until when the light reflected by the movable part 11 is incident on a light receiving element. The second sensor 142 is configured to output a second signal S2 corresponding to the distance between the movable part 11 and the base part 12. The second signal S2 may be an analog signal or a digital signal.

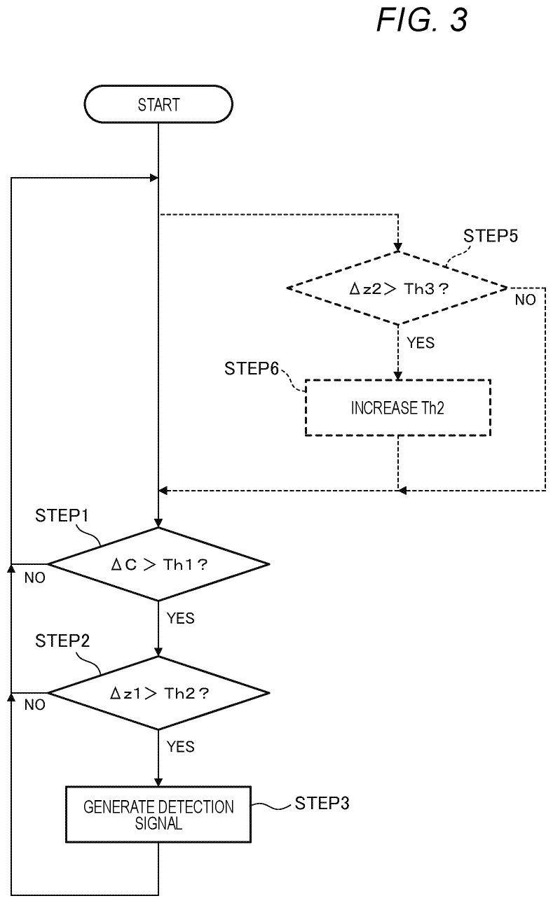

The instruction input device 10 includes a control device 15. The control device 15 includes an input interface 151 and a processor 152. The input interface 151 receives the first signal S1 outputted from the first sensor 141 and the second signal S2 outputted from the second sensor 142. In a case where the first signal S1 and the second signal S2 are analog signals, the input interface 151 includes an appropriate conversion circuit including an AID conversion circuit. Based on the first signal S1 and the second signal S2, the processor 152 determines whether an instruction input is performed with respect to the movable part 11. FIG. 3 illustrates details of a flow of processing to be executed by the processor 152.

Based on the first signal S1, the processor 152 determines whether a variation AC in the electrostatic capacitance of the movable part 11 exceeds a first threshold value Th1 (STEP1). The variation ΔC in the electrostatic capacitance is acquired as a change with time of the electrostatic capacitance corresponding to the first signal S1. The first threshold Th1 may be prescribed based on a variation in the electrostatic capacitance assumed to occur when the finger F of a general user contacts the movable part 11, or may be registered in advance for each user. The processing is repeated until it is determined that the variation ΔC in the acquired electrostatic capacitance exceeds the first threshold value (NO in STEP1).

When it is determined that the obtained variation ΔC in the electrostatic capacitance exceeds the first threshold value Th1 (YES in STEP1), the processor 152 acquires a first displacement amount Δz1, which is a displacement amount from the initial position of the movable part 11, based on the second signal S2. In addition, in STEP2, the processor 152 determines whether the first displacement amount Δz1 exceeds a second threshold value Th2. The second threshold Th2 may be prescribed based on a displacement amount of the movable part 11 that is assumed to be caused by a load caused by an intentional touch operation performed by a general user, or may be registered in advance for each user. When it is determined that the acquired first displacement amount Δz1 does not exceed the second threshold Th2 (NO in STEP2), the processing returns to STEP1.

When it is determined that the acquired first displacement amount Δz1 exceeds the second threshold value Th2 (YES in STEP2), the processor 152 generates a detection signal SS indicating that an effective touch operation (i.e., an instruction input) is performed with respect to the movable part 11 (STEP3). Thereafter, the processing returns to STEP1.

As illustrated in FIG. 1, the control device 15 includes an output interface 153. The generated detection signal SS is outputted from the output interface 153. The detection signal SS may be an analog signal or a digital signal. In a case where the detection signal SS is an analog signal, the output interface 153 includes an appropriate conversion circuit including a D/A converter. The detection signal SS is received by a controlled device. The controlled device executes appropriate processing based on the detection signal SS.

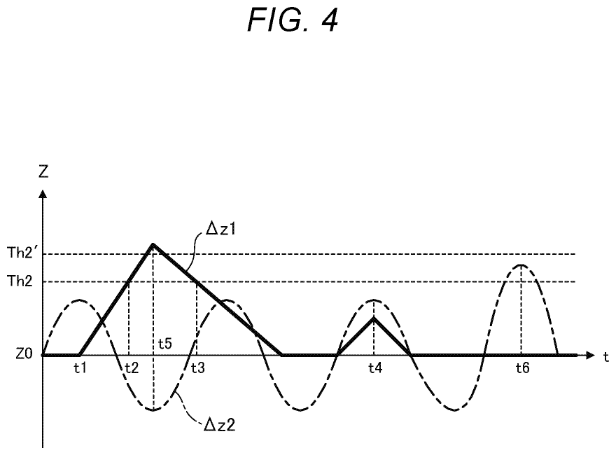

An example of the operation of the instruction input device 10 configured as described above will be described with reference to FIG. 4. The horizontal axis represents the elapse of time t. The vertical axis indicates the position of the movable part 11 detected by the second sensor 142. The increase in the value of the vertical axis means that the movable part 11 approaches the base part 12. A reference z0 represents an initial position of the movable part 11. A thick solid line indicates a change with time in the position of the movable part 11. Here, it is assumed that the displacement of the movable part 11 occurs only when the finger F of the user touches the movable part 11. Accordingly, the change with time in the position of the movable part 11 corresponds to a change with time in the first displacement amount Δz1 that is the displacement amount from the initial position z0.

At a time point t1, a displacement occurs in the movable part 11. Accordingly, the processor 152 determines that a variation ΔC in the electrostatic capacitance in the movable part 11 exceeds the first threshold value Th1 (YES in STEP1 in FIG. 3). Thereafter, at a time point t2, the first displacement amount Δz1 of the movable part 11 exceeds the second threshold Th2 (YES in STEP2 in FIG. 3). Accordingly, the processor 152 determines that an instruction input is performed with respect to the movable part 11, and generates a detection signal SS (STEP3). The generation of the detection signal SS is continued until a time point t3 when the first displacement amount Δz1 no longer exceeds the second threshold value Th2.

Thereafter, at a time point t4, another displacement occurs in the movable part 11. Accordingly, the processor 152 determines that a variation ΔC in the electrostatic capacitance in the movable part 11 exceeds the first threshold value Th1 (YES in STEP1 in FIG. 3). However, even at a time point t5 when the displacement has the maximum value, the first displacement amount Δz1 does not exceed the second threshold Th2 (NO in STEP2 in FIG. 3). Accordingly, the processor 152 does not determine that an instruction input is performed with respect to the movable part 11.

That is, it is possible to enable the control device 15 to determine that an instruction input is performed in a case where an operation is performed with a load sufficient to cause a displacement exceeding the second threshold value Th2 is applied to the movable part 11. For example, even if a user boarding the vehicle 1 touches the movable part 11 unintentionally so that the variation ΔC in the electrostatic capacitance of the movable part 11 exceeds the first threshold value Th1, the control device 15 does not determine that an instruction input is performed with respect to the movable part 11. Since it is possible to suppress the occurrence of a situation that the controlled device happens to be operated based on an unintended contact with the movable part 11, it is possible to improve the convenience of the instruction input device 10 based on the electrostatic capacitance detection system adapted to be installed in the vehicle 1.

The instruction input device 10 installed in the vehicle 1 may be subjected to vibration. The initial position of the movable part 11 may be displaced by such vibration. The dashed line in FIG. 4 illustrates a temporal change in the initial position of the movable part 11 caused by the vibration applied to the movable part 11 in a state where the user does not contact the movable part 11. In the following descriptions, the displacement amount of the initial position of the movable part 11 caused by the vibration applied to the movable part 11 will be referred to as a second displacement amount Δz2. In a state that the user does not contact the movable part 11, the change with time in the initial position of the movable part 11 corresponds to the change with time in the second displacement amount Δz2. When the initial position of the movable part 11 is displaced in a direction away from the base part 12 relative to the initial position z0 of the no-vibration condition, the second displacement amount Δz2 takes a negative value.

The actual position of the movable part 11 is expressed as a sum of the first displacement amount Δz11 and the second displacement amount Δz2 Accordingly, focusing on only the relationship between the distance from the initial position z0 and the second threshold Th2, there would be a case where the determination that the instruction input is performed is not performed as described above.

For example, at a time point t6, although a displacement sufficient to exceed the second threshold Th2 occurs in the movable part 11 under the no-vibration condition, the actual position of the movable part 11 that is represented by the sum of the first displacement amount Δz1 and the second displacement amount Δz2 does not reach the position corresponding to the second threshold Th2 because the vibration causes the initial position of the movable part 11 to displace in the direction away from the base part 12. As a result, there would be a case where an intentional operation is inputted by a user to the movable part 11 but the operation happens not to be recognized as an instruction input.

On the other hand, at a time point t5, although a displacement that never exceeds the second threshold Th2 occurs in the movable part 11 under the no-vibration condition, the actual position of the movable part 11 that is represented by the sum of the first displacement amount Δz1 and the second displacement amount Δz2 reaches the position corresponding to the second threshold Th2 because the vibration causes the initial position of the movable part 11 to displace in the direction approaching the base part 12. As a result, there would be a case where, even if a user touches the movable part 11 unintentionally, the touch happens to be recognized as an intentional instruction input.

In order to cope with such a problem, as illustrated in FIG. 1, the instruction input device 10 may be equipped with a third sensor 143. The third sensor 143 is configured to detect an acceleration applied to the movable part 11. The third sensor 143 may be a well-known acceleration sensor disposed in the movable part 11 or the base part 12. The third sensor 143 is configured to output a third signal S3 corresponding to the acceleration applied to the movable part 11. The input interface 151 of the control device 15 receives the third signal S3.

The processor 152 of the control device 15 may be configured to acquire the second displacement amount Δz2, which is the displacement amount of the initial position of the movable part 11, based on the acceleration applied to the movable part 11 indicated by the third signal S3. In addition, the processor 152 may be configured to acquire a third displacement amount Δz3, which is a difference between the first displacement amount Δz1 and the second displacement amount Δz2. The third displacement amount Δz3 is acquired as an absolute value of a value obtained by subtracting the second displacement amount Δz2 from the first displacement amount Δz1 or an absolute value of a value obtained by subtracting the first displacement amount Δz1 from the second displacement amount Δz2

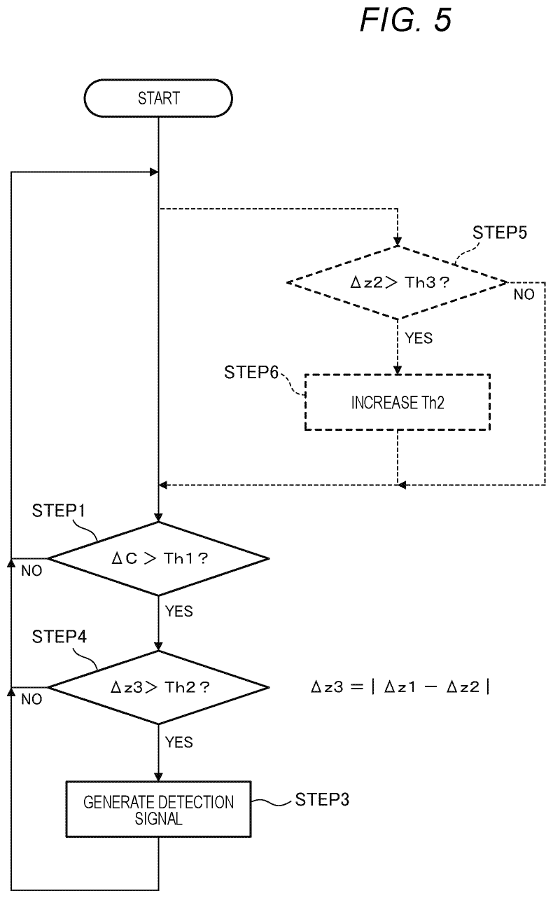

FIG. 5 illustrates an example of specific processing to be executed by the processor 152 configured as described above. Processes substantially the same as those illustrated in FIG. 3 are assigned with the same reference numerals, and repetitive descriptions for those will be omitted.

In this example, when it is determined that the obtained variation AC in the electrostatic capacitance exceeds the first threshold value Th1 (YES in STEP1), the processor 152 determines whether the third displacement amount Δz3 obtained as described above exceeds the second threshold value Th2 (STEP4). When it is determined that the acquired third displacement amount Δz3 does not exceed the second threshold Th2 (NO in STEP4), the processing returns to STEP1.

When it is determined that the acquired third displacement amount Δz3 exceeds the second threshold value Th2 (YES in STEP4), the processor 152 generates a detection signal SS indicating that an effective touch operation (i.e., an instruction input) is performed with respect to the movable part 11 (STEP3). Thereafter, the processing returns to STEP1.

According to such a configuration, it is possible to suppress the influence of the vibration applied to the instruction input device 10 from the vehicle 1, thereby enabling determination as to whether the instruction input is performed based on a substantial displacement amount of the movable part 11. Accordingly, it is possible to further improve the convenience of the instruction input device 10 based on the electrostatic capacitance detection system adapted to be installed in the vehicle 1.

For example, at the time point t6 illustrated in FIG. 4, the difference between the first displacement amount Δz1 and the second displacement amount Δz2 exceeds the distance from the initial position z0 to the position corresponding to the second threshold value Th2 (YES in STEP4 in FIG. 5). Accordingly, the processor 152 correctly determines that an instruction input is performed with respect to the movable part 11, and generates a detection signal SS (STEP3).

On the other hand, at the time point t5 illustrated in FIG. 4, the difference between the first displacement amount Δz1 and the second displacement amount Δz2 does not exceed the distance from the initial position z0 to the position corresponding to the second threshold value Th2 (NO in STEP4 in FIG. 5). Accordingly, the processor 152 correctly determines that no instruction input is performed with respect to the movable part 11.

The processor 152 of the control device 15 may be configured to increase the second threshold value Th2 when the second displacement amount Δz2, which is the displacement amount of the initial position of the movable part 11, exceeds a third threshold value Th3. That is, as illustrated in FIG. 5, the processor 152 of the control device 15 determines whether the second displacement amount Δz2 acquired based on the third signal S3 exceeds the third threshold value Th3 (STEP5).

When it is determined that the second displacement amount Δz2 exceeds the third threshold Th3 (YES in STEP5), the processor 152 increases the second threshold Th2 (STEP6). Thereafter, the processing proceeds to STEP1. When it is determined that the second displacement amount Δz2 does not exceed the third threshold value Th3 (NO in STEP5), the processing proceeds to STEP1 while the second threshold value Th2 is maintained.

At a time point t7 illustrated in FIG. 4, a relatively large vibration is applied to the instruction input device 10, so that the initial position of the movable part 11 approaches the base part 12 beyond the position corresponding to the second threshold Th2. In this case, there would be a situation where a determination that an instruction input is performed happens to be made even though no displacement occurs in the movable part 11 due to an operation of a user. In order to avoid such a situation, the third threshold Th3 is determined to have a value that is no greater than the second threshold Th2.

That is, in a case where the initial position of the movable part 11 changes relatively largely due to vibration or impact applied to the instruction input device 10 from the vehicle 1, a change of increasing the second threshold Th2 is performed in advance. In FIG. 4, the second threshold value after the change is indicated by a reference Th2′.

According to such a configuration, it is possible to suppress the occurrence of a situation where the determination that an instruction input is performed happens to be made even if the user does not intentionally operate the movable part 11. Accordingly, it is possible to further improve the convenience of the instruction input device 10 based on the electrostatic capacitance detection system adapted to be installed in the vehicle 1.

The processing of increasing the second threshold Th2 in a case where the second displacement amount Δz2 exceeds the third threshold Th3 can be applied to the processing illustrated in FIG. 3 as well. That is, the third signal S3 corresponding to the acceleration applied to the movable part 11 can be used only for determining whether or not the increase of the second threshold value Th2 is necessary without being used for obtaining the third displacement amount Δz3. According to such a configuration, it is also possible to suppress the occurrence of a situation where the determination that an instruction input is performed happens to be made even if the user does not intentionally operate the movable part 11.

The processor 152 having various functions described above can be implemented by a general-purpose microprocessor operating in cooperation with a general-purpose memory. Examples of the general-purpose microprocessor include a CPU, an MPU, and a GPU. Examples of the general-purpose memory include a ROM and a RAM. In this case, a computer program for executing the above-described processing can be stored in the ROM. The ROM is an example of a non-transitory computer-readable medium having stored a computer program. The general-purpose microprocessor designates at least a part of the program stored in the ROM, loads the program on the RAM, and executes the processing described above in cooperation with the RAM. The above-described computer program may be pre-installed in a general-purpose memory, or may be downloaded from an external server via a communication network (not illustrated) and then installed in the general-purpose memory. In this case, the external server is an example of the non-transitory computer-readable medium having stored a computer program.

The processor 152 may be implemented by an exclusive integrated circuit such as a microcontroller, an ASIC, and an FPGA capable of executing the above-described computer program. In this case, the above-described computer program is pre-installed in a memory element included in the exclusive integrated circuit. The memory element is an example of a non-transitory computer-readable medium having stored a computer program. The processor 152 may be implemented by a combination of the general-purpose microprocessor and the exclusive integrated circuit.

The above embodiments are merely illustrative for facilitating understanding of the gist of the presently disclosed subject matter. The configuration according to each of the above embodiments can be appropriately modified or changed without departing from the gist of the presently disclosed subject matter.

The touch operation detected through the movable part 11 is not necessarily performed with the finger F of the user. A touch operation performed with a body part such as a palm, an elbow, a knee, and a toe can also be detected.

The mobile entity in which the instruction input device 10 is installed is not limited to the vehicle 1. Examples of other mobile entities include railways, ships, and aircrafts. Such mobile entities may not require a driver.

The present application is based on Japanese Patent Application No. 2019-202276 filed on Nov. 7, 2019, the entire contents of which are incorporated herein by reference.

1. An instruction input device adapted to be installed in a mobile entity, comprising:
a movable part configured to be displaced;
a first sensor configured to detect an electrostatic capacitance at the movable part;
a second sensor configured to detect a position of the movable part; and
a control device configured to output a signal indicating that an instruction input is performed through the movable part in a case where a variation in the electrostatic capacitance exceeds a first threshold value and a first displacement amount that is a displacement amount of the movable part from an initial position thereof exceeds a second threshold value.

2. The instruction input device according to claim 1, further comprising:
a third sensor configured to detect an acceleration applied to the movable part,
wherein the controller is configured to:
acquire, based on the acceleration, a second displacement amount that is a displacement amount of the initial position;
acquire a third displacement amount that is a difference between the first displacement amount and the second displacement amount; and
output the signal in a case where the third displacement amount exceeds the second threshold value.

3. The instruction input device according to claim 2,
wherein the controller is configured to increase the second threshold value in a case where the second displacement amount exceeds a third threshold value.

4. The instruction input device according to claim 1, further comprising:
a third sensor configured to detect an acceleration applied to the movable part,
wherein the controller is configured to:
acquire, based on the acceleration, a second displacement amount that is a displacement amount of the initial position; and
increase the second threshold value in a case where the second displacement amount exceeds a third threshold value.

5. A control device adapted to be installed in a mobile entity, comprising:
an input interface configured to receive a first signal corresponding to an electrostatic capacitance at a movable part that is configured to be displaced, and a second signal corresponding to a position of the movable part; and
a processor configured to:
determine, based on the first signal and the second signal, whether it is satisfied a condition in which a variation in the electrostatic capacitance exceeds a first threshold value and a first displacement amount that is a displacement amount of the movable part from an initial position thereof exceeds a second threshold value; and
output a signal indicating that an instruction input is performed through the movable part in a case where the condition is satisfied.

6. A non-transitory computer-readable medium having stored a computer program adapted to be executed by a processor of a control device adapted to be installed in a mobile entity, the computer program being configured, when executed, to cause the control device to:
receive a first signal corresponding to an electrostatic capacitance at a movable part that is configured to be displaced, and a second signal corresponding to a position of the movable part;
determine, based on the first signal and the second signal, whether it is satisfied a condition in which a variation in the electrostatic capacitance exceeds a first threshold value and a first displacement amount that is a displacement amount of the movable part from an initial position thereof exceeds a second threshold value; and
output a signal indicating that an instruction input is performed through the movable part in a case where the condition is satisfied.
